(19) United States
(12) Patent Application Publication
(10) Pub. No.: US 2003/0194468 A1
(43) Pub. Date: Oct. 16, 2003

(54) Dairy beverage and method of preparation thereof

(76) Inventors: Amy Konkoly, Eden Prairie, MN (US); Marthena A. Baker, Plymouth, MN (US); Penny L. Norquist, St. Paul, MN (US); Tonya C. Schoenfuss, St. Louis Park, MN (US); Thomas J. Springer, Crystal, MN (US); Michelle Zacho, Anoka, MN (US)

Correspondence Address: GENERAL MILLS, INC., P.O. BOX 1113, MINNEAPOLIS, MN, 55440, US

(21) Appl. No.: 10/121,637

(22) Filed: Apr. 12, 2002

(51) Int. Cl. A23C 9/12

(52) U.S. Cl. 426/34

(57) ABSTRACT

A method for the production of an acidified nutritionally fortified cultured dairy beverage or yogurt product and the resulting product containing live and active cultures comprising preparing a non-fermented fluid dairy base, homogenizing and pasteurizing said base mix, adding a yogurt to said base mix, adding an acid blend to said base mix, comminuting said base mix to reduce particle size, adding a flavor and a color to said base mix, and packaging to provide an acidified nutritionally fortified cultured dairy beverage composition containing live and active cultures, having a finished product culture count of at least 1.5×10⁸ cfu/gram, a viscosity of 400 to 3500 cps at a temperature of 1° C. to 7° C. and a final pH of 3.8 to 4.5.

### BACKGROUND OF THE INVENTION

The present invention relates to food products and their methods of preparation. More particularly, the present invention relates to fermented milk based nutritionally fortified beverages and to their methods of preparation.

There have been many efforts in the art to develop dairy beverages, particularly nutritionally fortified dairy beverages. The middle-aged and older consumer finds dairy beverages appealing as a result of a desire to manage weight, improve physical performance and overall health. Likewise, ready-to drink flavored dairy beverages have a great deal of appeal to the child consumer. Additionally, the convenience offered by beverages is especially appealing for consumers who do not have the time or desire to consume a conventional meal. Many consumers view dairy and dairy-alternative beverages as an ideal meal replacement. To serve as a convenient dairy beverage, a product should be a portable ready-to-drink food product which requires no cooking or preparation, no application of additional ingredients, and so forth. Ideally a convenient dairy beverage does not require the use of utensils such that it can be consumed in nearly any location at any time, including while driving, traveling on an airplane, walking, and so forth.

Some of the most popular dairy beverages are refrigerated ready-to-drink yogurt products that are packaged in disposable packaging materials. While containing live and active yogurt cultures, such refrigerated yogurt beverage products are not strongly nutritionally fortified; i.e., lack sufficient fortification to be considered full meal replacement foods. Specifically, many beverages lack adequate protein, vitamins, minerals, fiber and so forth to be considered a meal replacement due in part to the difficulty of fortifying a yogurt product without creating off-flavors and destabilizing the product.

Further, those dairy beverages that are nutritionally fortified generally do not contain live and active cultures when sold to the consumer, due in part to the heat-treatment the beverage must undergo for shelf-stability.

Surprisingly, the present invention provides milk based beverages that not only contain nutritional fortification to be full meal replacement foods but also comprise live and active yogurt cultures.

The present milk based beverages are prepared by and the present methods of preparation essentially comprise blending a heat treated fortified milk blend having a higher pH with a lower pH having yogurt live and active cultures to form a milk base/yogurt blend and thereafter adjusting the pH of the blend so formed to form a nutritionally fortified refrigerated yogurt-based product of enhanced stability.

Thus, this invention relates to a method for the production of a convenient food beverage that has improved nutritional and organoleptic characteristics, yet maintains desirable yogurt characteristics having live and active cultures.

### BRIEF SUMMARY OF THE INVENTION

In its method aspect, the present invention provides methods for preparing an acidified nutritionally fortified cultured dairy beverage containing live and active cultures. The present methods comprising preparing a non-fermented, at least pasteurized, homogenized fluid dairy base; admixing a yogurt to said base to form a blend, adding an acid blend to said base mix, comminuting said base mix to reduce particle size, adding a flavor and a color to said base mix, and packaging to provide a fluid nutritionally fortified dairy beverage composition.

The invention also relates to the acidified dairy beverage thus produced. The fermented milk based nutritionally fortified beverages can be characterized as having a culture count of at least 1.5×10⁸ cfu/gram, and having a finished product viscosity of 400 to 3500 cps at a temperature of 1° C. to 5° C. and a final pH of 3.8 to 4.5.

### BRIEF DESCRIPTION OF THE DRAWINGS

FIG. 1 is a schematic process flow diagram illustrating the method of preparation of the present invention.

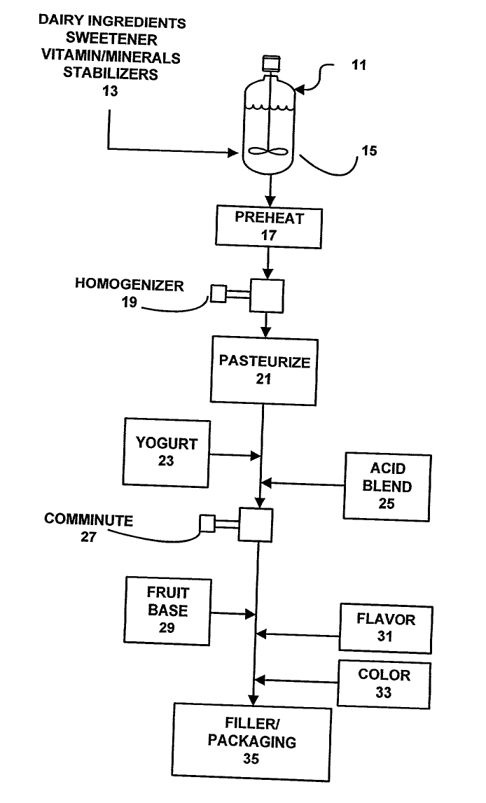

### DETAILED DESCRIPTION OF THE INVENTION

This invention relates to a method for the production of an acidified nutritionally fortified cultured dairy beverage containing live and active cultures. The invention also relates to the acidified dairy beverage thus produced. Each of the preparation steps as well as product components, product use and attributes are described in detail below.

The present invention can, of course, be carried out in other specific ways than those herein set forth without departing from the spirit and essential characteristics of the invention. The present embodiments are, therefore, to be considered in all respects as illustrative and not restrictive and all changes coming within the meaning and equivalency range of the appended claims are intended to be embraced herein.

Throughout the specification and claims, percentages are by weight and temperatures in degrees Celsius unless otherwise indicated.

Referring now to the drawing, the present invention relates to methods [11] of preparing a fermented milk based nutritionally fortified beverages comprising a non-fermented fluid dairy base mix [13] comprising a dairy ingredient, a sweetener, a thickener, at least a vitamin, optionally at least a mineral, and optionally an alkaline salt blend; admixing [15], preheating [17], homogenizing [19], and pasteurizing [21] said base mix, adding a yogurt [23] comprising a dairy ingredient, water, and at least a live and active culture to said base mix, adding an acid blend [25] to said base mix, comminuting [27] said base to reduce particle size, adding a fruit base [29], a flavor

and a color [33] to said base mix, packaging [35] said base mix to provide a fluid nutritionally fortified yogurt product with live and active cultures having a shelf life of up to sixty (60) days and a finished pH of 3.8 to 4.5.

The first essential step is to provide a non-fermented fluid at least pastueurized dairy base comprising a dairy ingredient, a sweetener, a thickener, at least a first added vitamin, optionally at least a first added mineral, and optionally an emulsifying salt blend.

Conveniently, this first step can include the substeps of (1) admixing the essential ingredients to form a non-fermented fluid dairy base mix, (2) homogenizing said base mix, and (3) pasteurizing said homogenized base mix.

A dairy ingredient preferred for use herein can be non-fat dry milk reconstituted with water to provide a reconstituted milk having a solids content of about 3.5% to about 4.5%. In other variations, all or part of the nonfat dry milk solids can be substituted on an equivalent solids basis by one or more dairy ingredients such as whole milk, skim milk, condensed milk, grade A whey, cream and/or such other milk fraction ingredients such as buttermilk, whey, lactose, lactalbumins, lactoglobulins, or whey modified by partial or complete removal of lactose and or minerals, and other dairy ingredients to increase the non-fat solids content, which are blended to provide the desired fat, non-fat solids, and protein content.

Also, while bovine milk is preferred, other milks or milk ingredients can be used in substitution for bovine milk whether in whole or in part, e.g., goat, sheep or equine milk. In less preferred embodiments, the base mix can comprise a vegetable milk such as soy, and nut milk.

Addition of a sweetener to the non-fermented base mix comprises the preferred additional sub-step of admixing liquid or granular sucrose and high fructose corn syrup prior to addition to the base mix. Although less preferred, other exemplary useful sweetening agents include, but are not limited to, dextrose, various DE corn syrups, invert sugar (in paste or syrup form), brown sugar, refiner's syrup, molasses (other than blackstrap), fructose, fructose syrup, maltose, maltose syrup, dried maltose syrup, malt extract, dried malt extract, malt syrup, dried malt syrup, honey, maple sugar, aspartame, potassium acelsufame, saccharin, cyclamates, thaumatin, sucrolose, and mixtures therof. The dairy base comprises about 9% to about 15% by weight of the sweetener.

The thickeners or stabilizers contained in the non-fermented base mix preferably comprise a high methoxy pectin having a DE of 50% or greater, most preferred is an amidated high methoxy pectin. The dairy base comprises about 0.1% to about 1.2% by weight of stabilizers or thickeners, preferably about 0.5% to about 1.2% by weight. The pectin beneficially provides stabilization or prevents coagulation of proteins resulting in improved mouthfeel or texture of the finished product. Although other direct acidified dairy beverages are stabilized with high methoxy pectin and amidated high methoxy pectin, the addition of the pectin in other dairy beverages is post-pasteurization, which is in contrast to pre-pasteurization addition of pectin as in the present invention. It is speculated that other direct acidified products maintain separate pectin and dairy ingredient streams until pasteurization is complete in order to eliminate the destabilizing and precipitation effect heat has on milk proteins in a dairy base with a pH of less than 6.5. Surprisingly, the addition of an emulsifying and buffering salt blend addresses the issues of addition of amidated high methoxy pectin in said pre-pasteurized non-fermented dairy base mix as further described below. Other stabilizers which can be used include starch, gellan gum, carboxy methyl cellulose, gelatin (less preferred due to concern related to mad cow disease), sodium alginate, and hydroxy propyl methyl cellulose and mixtures thereof.

The food products of present invention essentially includes adding or fortifying i.e., to increase from the native level in the milk, if present therein, with at least one added vitamin in said non-fermented dairy base mix to form a nutritionally fortified non-fermented dairy base mix. The vitamin and optionally at least one mineral, are contained in a fine powder blend when admixed with the non-fermented dairy base mix. The present invention preferably contains at least six different added vitamins and/or minerals in the powder blend. In one preferred embodiment, the present invention includes, per eight fluid ounces of finished product from about:

| Compound | units | Quantity |
|---|---|---|
| Vitamin A | IU | 250-1750 |
| Vitamin D | IU | 20-140 |
| Vitamin E | IU | 1.5-10.5 |
| Vitamin C | mg | 3-21 |
| Folate | mcg | 20-140 |
| Thiamin (B1) | mg | 0.075-0.525 |
| Riboflavin (B2) | mg | 0.085-0.595 |
| Niacin | mg | 1-7 |
| Pyridoxine (B6) | mg | 0.1-0.70 |
| Cyanocobalamine (B12) | mcg | 0.4-2.8 |
| Biotin | mcg | 15-105 |
| Pantothenic Acid | mg | 0.5-3.5 |
| Calcium (Ca) | mg | 50-350 |
| Phosphorus (P) | mg | 50-750 |
| Iodine (I) | mg | 7.5-52.5 |
| Iron (Fe) | mg | 0.9-6.3 |
| Magnesium (Mg) | mg | 20-140 |
| Zinc (Zn) | mg | 0.75-5.25 |
| Manganese (Mn) | mg | 0.1-0.70 |

mg = milligrams (0.001 g)
mcg = micrograms (0.000001 g)
IU = International Units

The fortification level of the present invention can be adjusted, adult beverages can be considered meal replacements necessitating high levels of fortification, while it is less desirable to have a highly fortified child-oriented beverage as such beverages are not considered meal replacements.

The present invention can include the addition of a soluble fiber, such as inulin. The inulin can be admixed in the nutritionally fortified non-fermented dairy base mix.

Additionally, potassium sorbate or other mold prevention ingredients can be added to the dairy base mix at typical levels. For example, the present compositions can beneficially comprise about 0.01 to about 0.05% of such mold inhibiting ingredients.

The nutritionally fortified non-fermented base mix additionally essentially comprise sufficient amounts of an alkaline salt blend to prevent milk protein precipitation during pasteurization. Good results are obtained when the base mix comprises about 0.5% to about 1.5% of a salt blend comprising at least a chelator and at least a buffering agent. The base mix has a pre-pasteurization pH of about 6.0 to 6.6 at 4.5° C. A pre-pasteurization pH of less than 6.5 can be undesirable for heat-treating the milk proteins contained in the non-fermented dairy base causing destabilization and precipitation of the milk proteins. Addition of salt blends that increase the pH can aid in the successful pasteurization of the non-fermented dairy base mix preventing destabilization and precipitation of the proteins. The addition of the salt blend to said base mix can include the additional sub-step of creating a salt blend. Preferred for use herein is a salt blend of sodium citrate, sodium monophosphate, and polyphosphates known as JOHA KM2 purchased from BK Giulini, 2345 Erringer Rd., Suite 221, Simi Valley, Calif. 93065 for use with ultra-high temperature processed products. While not wishing to be bound by the proposed theory, it is speculated herein that sodium citrate acts as a chelator for the calcium in the base mix and the sodium monophosphate, and polyphosphates, act as buffering agents. Alternative chelators for the salt blend can be acetates, adipates, ascorbates, fumarates, malates, phosphates, potassium citrates (e.g., trisodium citrate), tartrates, and mixtures thereof. Alternative buffering ingredients for the emulsifying salt blend can be disodium phosphate, sodium hexametaphosphate, trisodium phosphate, tetrasodium pyrophosphate, and mixtures thereof.

The nutritionally fortified non-fermented dairy base mix is then pre-heated to a temperature of about 62° C. to 75° C., preferably 74° C. Pre-heating the dairy base mix increases the product viscosity and denatures the whey proteins, thereby optimizing the organoleptic properties of the finished product.

The next essential step of the present process comprises homogenizing the nutritionally fortified non-fermented dairy base mix, preferably using a two stage homogenizer common in the art, wherein the first stage of the homogenizer reduces the globule size and the second stage breaks up the overall clusters, such that the pasteurized and homogenized dairy base mix has a mean particle size of 5 to 20 microns. The reduction in particle size of the dairy base mix aids the pectin during stabilization of the proteins.

The nutritionally fortified non-fermented dairy base mix is then at least pasteurized, typically by heating for times and temperatures effective to accomplish pasteurization to form a pasteurized nutritionally fortified non-fermented dairy base mix. As is well known, the dairy base mix can be heated to lower temperatures for extended times, e.g., 88° C. for 30 minutes or alternately to higher temperatures, e.g., 95° C. for shorter times, e.g. for about 38 seconds. Of course intermediate temperatures for intermediate times can also be employed. Other non thermal pasteurization techniques can be practiced (e.g., light pulse, ultra high pressure, etc.) if effective and economical. The pasteurized and homogenized dairy base mix is then cooled to about 1° C. to 8° C., preferably 4° C. The cooled pasteurized and homogenized dairy base mix can be characterized as having a viscosity of about 900 cps to about 1800 cps.

Although less preferred, the sub-steps of homogenizing and pasteurizing the base mix can be reversed, thus eliminating the pre-heating sub-step.

The second essential step is to provide a fermented dairy base such as yogurt containing at least 8.25% milk solids non-fat having live and active cultures. Conventional methods and techniques can be used to practice the step of producing the yogurt.

Conveniently, this second step can include the sub-steps of (1) providing a milk base, (2) homogenizing the milk base, (3) pasteurizing the homogenized milk base, (4) bringing the pasteurized milk base to fermenting temperatures such as by cooling, (5) adding a starter culture, and (6) fermenting to desired acidities and cooling to arrest the fermentation.

Briefly, the yogurt production process typically begins with raw milk, that may contain a combination of whole milk, skim milk, condensed milk, dry milk (dry milk solids non-fat or equivalently, “MSNF”), grade A whey, cream and/or such other milk fraction ingredients as buttermilk, whey, lactose, lactalbumins, lactoglobulins, or whey modified by partial or complete removal of lactose and or minerals, other dairy ingredients to increase the milk solids non-fat, which are blended to provide the desired fat and solids content. Preferred for use herein is non-fat dry milk admixed with water. In less preferred embodiments, the base mix can comprise a vegetable milk such as soy milk.

Additionally, while bovine milk is preferred, other milks can be used in substitution for bovine milk whether in whole or in part, e.g., goat, sheep, equine, soy, or nut milk or mixtures thereof.

In preferred variations, the milk base is free of ingredients that inhibit fermentation such as sugars, vitamins, fiber, stabilizers, etc. that can undesirably prolong the time needed for fermentation.

Next, the milk base is homogenized in a conventional homogenizer thereby forming a homogenized milk base. If desired, the milk base can be warmed prior to homogenization from typical milk storage temperatures of about 5° C., to temperatures of about 65° C. to 75° C.

This homogenized milk base is then pasteurized, typically by heating for times and temperatures effective to accomplish pasteurization to form a pasteurized milk base. As is well known, the milk base can be heated to lower temperatures for extended times, e.g., 88° C. for 30 minutes or alternately to higher temperatures, e.g., 95° C. for shorter times, e.g. for about 38 seconds. Of course intermediate temperatures for intermediate times can also be employed. Other pasteurization techniques can be practiced (e.g., light pulse, ultra high pressure, etc.) if effective and economical. In certain commercial practices, the sequence of the homogenization and pasteurization steps can be reversed.

The homogenized and pasteurized base is then brought to incubation temperature, usually about 40° C. to 46° C. When heat pasteurization is employed, this step typically is a cooling step.

Thereafter, the homogenized and pasteurized milk blend is inoculated with a desired culture. Usually, a combination of Lactobacillus bulgaricus and Streptococcus thermophilus bacteria is added to begin the fermentation process. In other variations, the yogurt culture can additionally include a Lactobacillus bifidus and/or a Lactobacillus acidophilus bacteria. The fermentation step, is quiescently continued until the pH of the milk blend reaches approximately 4.4 to 4.6 to form a yogurt base. Depending upon such operational conditions as temperature, amount of culture added, the form of the culture, the specific culture strains, and the bulk starters, fermentation can take from about three to about 14 hours. It is important that the mixture not be agitated during the fermentation process to allow proper curd formation. When the proper pH has been reached, the yogurt is cooled (e.g., to about 2° C. to 21° C.) to arrest further growth and any further drop in pH.

The particular fermentation endpoint pH can vary modestly. Typically, the endpoint pH can range from about 4.2 to 4.7, preferably about 4.45 to 4.55. The yogurt base so prepared exhibits a culture count generally greater than 5×10⁸ colony-forming units (cfu)/gram to about 7×10⁸ cfu/gram. Once the desired finished yogurt pH is obtained, the fermentation step is arrested by cooling the yogurt base to temperatures ranging from about 5 to 10° C.

Thus prepared, the yogurt base importantly is characterized by a viscosity of at least 500 cps, preferably at least 800 cps (at 5° C.). At a viscosity of 800 cps, the yogurt base is a thin fluid substance useful for a yogurt beverage-type product. The yogurt base is gently pumped or otherwise handled to provide a stirred style yogurt base in a manner that imparts minimal shear to the yogurt in order to maintain the viscosity of the yogurt.

The yogurt is admixed with the pasteurized nutritionally fortified dairy base mix thereby providing a nutritionally fortified cultured dairy beverage to form a yogurt/fortified dairy base blend. Good results are obtained when the ratio of yogurt to pasteurized nutritionally fortified dairy base mix is about 1:3.5 to about 1:6 in the yogurt/fortified dairy base blend.

The next essential step comprises reducing the pH of the yogurt base/fortified milk base blend to within the essential pH range without causing precipitation to provide an acidified nutritionally fortified cultured dairy beverage. Of course, blending the yogurt base with the fortified milk base results in some lowering of the pH of the nutritionally fortified cultured dairy beverage. Good results can be obtained by adding sufficient amounts of edible acids to provide the blend with the desired pH within this range. Preferred for use herein are filter sterilized edible food grade organic acids including adipic acid, citric acid, fumeric acid, lactic acid, malic acid, succinic acid and mixtures thereof. For best flavor, preferred herein is a mixture of citric and lactic acid especially in a 1:1 weight ratio. In another variation, the acid blend is comprised of citric acid, malic acid, lactic acid, and mixtures thereof. Useful in full or partial substitution for the preferred acids herein are adipic, fumaric, phosphoric, succinic, tartaric, and mixtures thereof. In certain variations, the acid blend can further comprise the salts of the acids, e.g., sodium citrate. Good results are obtained when the amount of edible acid ranges from about 0.5% to 1.5% of the blend. The acid(s) is typically dissolved in minimal amounts of water to provide a solution that is more conveniently admixed with the blend. The acidified nutritionally fortified cultured dairy beverage has a pH of about 4.2 to about 4.5 after addition of the acid blend.

The next essential step comprises comminuting or size reducing the nutritionally fortified cultured dairy beverage using a conventional dynamic shear pump, homogenizer, or a combination thereof, such that the beverage surprisingly maintains stability while having a mean particle size of about 5 to about 25 microns. It has previously been thought that a dairy beverage having a particle size greater than 0.8 microns would not remain stable for any length of time. However, the present invention maintains stability for up to 60 days with a mean particle size of about 5 to about 25 microns. The comminuting step can occur at temperatures greater than 4° C., however, the preferred temperature for comminuting the nutritionally fortified cultured dairy beverage is 4° C.

Thereafter, an aseptic fruit base can optionally be added to the nutritionally fortified cultured dairy beverage. The fortified cultured dairy beverage can comprise about 2.5% to about 5% by weight fruit base, preferably about 3.0% to about 4% by weight fruit base. The fruit base can optionally assist in achieving a desired pH level for the finished product. An example of a useful fruit base comprises 45% to 60% by weight fruit solids, 15% to 20% by weight water, 5.0% to 6.0% dimagnesium phosphate trihydrate, 0.5% to 2% by weight starch, 0.50% to 0.90% by weight tricalcium phosphate, and the remaining composite containing acid, a sorbate, and optionally color and flavors. The optional fruit base can be in the form of a puree or alternatively contain visible shreds of fruit.

The addition of magnesium in a fruit base is well known, however most sources of magnesium cause an undesirable flavor in the finished product. Preferred for use herein is a dimagnesium phosphate which has the least negative flavor impact in the product while being “Generally Recognized As Safe” (GRAS) by the United States Food & Drug Administration. Alternative sources of magnesium are magnesium sulfate, magnesium oxide, magnesium chloride, magnesium carbonate, magnesium hydroxide, and mixtures thereof. Less preferred sources of magnesium are magnesium citrate and magnesium lactate, both sources have a more desirable flavor impact, however neither is a “GRAS” recognized ingredient.

Optionally, the next step comprises the addition of at least a flavor and at least a color in the nutritionally fortified cultured dairy beverage. The flavor and color addition can be a flavor/color blend of about 0.1% to about 0.8% by weight, preferably about 0.3% to about 0.5% by weight of the nutritionally fortified cultured dairy beverage.

Optionally, vitamins can be added to the flavor/color blend. Addition of vitamins to the flavor/color blend can minimize heat degradation of the vitamins, (e.g. Vitamin A, Vitamin C) and minimize off-flavors that can result from loss of the vitamins during pasteurization.

The nutritionally fortified cultured dairy beverage compositions of the present invention so prepared are preferably characterized by sufficient amounts of live and active yogurt cultures to provide an initial (i.e., at time of manufacture) culture count of at least 1.5×10⁸ cfu/gram. The nutritionally fortified cultured dairy beverage composition can be further characterized as having a culture activity demonstrating greater than a 1 log increase in cfu/gram in a standard activity test comparing the yogurt culture count at time of manufacture versus the yogurt culture count at the end of the products shelf-life. Care thus must be taken to avoid further processing that reduces or destroys the viability of the desirable live and active culture such as further heat or pressure treatments intended to pasteurize or sterilize the product prior to refrigerated temperature distribution and sale.

The nutritionally fortified cultured dairy beverage compositions of the present invention so prepared are further characterized as having a desirably low fat content of less than 1% by weight, more preferred low fat content of less than 0.5% by weight, and most preferred essentially fat free.

Additionally, one preferred embodiment of the present invention can be characterized as having a potassium to sodium ratio greater than 1:1, preferably about 2:1. Many products contain a sodium concentration higher than the potassium concentration, however maintaining an ionic balance such as in the present invention is desirable.

If desired, the present products can be carbonated to provide carbonated yogurt or yogurt beverages. Good results are obtained when sufficient amounts of carbon dioxide are dissolved to provide about 0.5 to 5 times the volume of carbon dioxide of the beverage in the beverage.

The present fermented milk beverage so prepared can be packaged in suitable containers for distribution and sale to provide packaged beverage food articles of the present invention. In the preferred embodiment, the beverage is then packaged in a multi-layer plastic bottle of suitable shape and size fabricated from container materials to minimize the development of oxidation off-flavors, thereby assisting in providing the beverage articles with a 60 day product shelf-life. Although less preferred, other suitable packages for the dairy beverage include gable top cartons and canned containers.

One preferred bottle can be a three-layer structure comprising a first outer layer of virgin white high density polyethylene, a intermediate layer comprised of a carbon black regrind, and a third inner layer of virgin white high density polyethylene that is in contact with the beverage. The carbon black bearing layer blocks out light to minimize light caused oxidation of the product.

An alternative bottle can be a six-layer structure comprising from the inside to the outside layer, a first layer of virgin white high density polyethylene, a second layer comprised of a carbon black regrind, a third layer comprised of adhesive, a fourth layer comprised ethylene vinyl alcohol, a fifth layer of adhesive, a sixth layer of virgin white high density polyethylene. The ethylene vinyl alcohol layer is an oxygen barrier. Typically one millimeter of ethylene vinyl alcohol can provide a 0.05 cc/(100 sq. inches)(day) oxygen permeability. With only the use of high density polyethylene, the oxygen permeability can be as high as 200 cc oxygen/(100 sq. inches)(day).

The bottle can then be sealed with a suitable closure preferably a closure having with a tamper evident feature such as a break away band and foil induction seal. The beverage products are then maintained in refrigerator storage (1-8° C.) for distribution and sale.

A nutritionally fortified cultured dairy beverage of the present invention was prepared having the following formulation.

### EXAMPLE 1

| | Weight % |
|---|---|
| Fortified, nonfermented dairy base ingredients | |
| Water | 74.0% |
| Non-fat dried milk | 8.8% |
| Sucrose | 8.9% |
| High Fructose Corn Syrup | 4.2% |
| Starch | 1.4% |
| Pectin | 0.5% |
| Gellan Gum | 0.06% |
| Inulin | 2% |
| Vitamin Blend | 0.03% |
| Emulsifying Salts | 0.1% |
| Potassium Sorbate | 0.03% |
| Comminute dairy base, yogurt and acid | |
| Dairy Base | 79% |
| Non fatYogurt | 19% |
| Acid Blend | 2% |
| Fruit, Flavor and color addition | |
| Acidified, cultured dairy base | 96.1% |
| Fruit puree | 3.5% |
| Flavor/Color blend | 0.4% |

A dairy base was prepared by admixing water, nonfat dried milk, sugar, starch, pectin, gellan gum, inulin, a vitamin blend, emulsifying salt blend, and potassium sorbate to form a wet blend that was homogenized and heat pasteurized, thereby reducing the particle size to about 13 to 20 microns. The vitamin blend contained a combination of at least twelve vitamins and minerals. The pasteurized base was then cooled to 4° C. The dairy base was then blended with nonfat yogurt and an acid blend comprising lactic, and citric acids. The dairy base, yogurt, acid blend was homogenized. Fruit puree, and a flavor and color blend were added to the base. The base was then mixed in-line with a static mixer. The beverage having a viscosity of about 2200 centipoise to about 3500 centipoise was then packaged in a high barrier bottle with a foil induction seal.

### EXAMPLE 2

A second nutritionally fortified cultured dairy beverage of the present invention was prepared having the following formulation.

| | Weight % |
|---|---|
| Fortified, nonfermented dairy base ingredients | |
| Water | 79.4% |
| NFDM | 5.6% |
| Sucrose | 8.6% |
| High Fructose Corn Syrup | 2.8% |
| Starch | 1.0% |
| Cream | 2.0% |
| Carboxymethyl cellulose | 0.2% |
| Modified cellulose | 0.2% |
| Pectin | 0.2% |
| Vitamin Blend | 0.02% |
| Potassium Sorbate | 0.03% |
| Comminute dairy base, yogurt and acid | |
| Dairy Base | 84% |
| Yogurt | 15% |
| Acid Blend | 1% |
| Fruit, Flavor and color addition | |
| Acidified, cultured dairy base | 96.1% |
| Fruit puree | 3.5% |
| Flavor/Color blend | 0.4% |

A dairy base comprising water, nonfat dried milk, cream, sugars, starch, pectin, carboxymethyl cellulose, cellulose gum, a vitamin and mineral blend, and potassium sorbate was homogenized and pasteurized, reducing the particle size to 5 to 15 microns. The heat-treated base was then cooled to 4° C. The vitamin blend contained a combination of at least six vitamins and minerals. It was then blended with nonfat yogurt and an acid blend comprising citric, lactic and malic acids. The dairy base, nonfat yogurt, and acid blend was then homogenized. Fruit puree, and a flavor and color blend were added to the base and it was mixed in-line with a static mixer. The beverage having a viscosity of about 400 centipoise to about 1000 centipoise was then packaged in a high density polyethylene bottle with an oxygen and UVA barrier layer and foil induction sealed.

What is claimed is:

1. A process for manufacture of a nutritionally fortified cultured dairy product comprising:
a. providing a pasteurized sweetened fortified base mix comprising a milk ingredient, a sugar, at least a first thickener, at least a first added vitamin, and at least a first added mineral,
b. adding a yogurt comprising a dairy ingredient, water, and at least a live and active culture to form a yogurt bearing sweetened fortified base mix having a initial pH of 5.0 to 6.5,
c. adding an edible organic acid to form an acidified yogurt bearing sweetened fortified base mix having a pH of 4.2 to 4.6,
d. comminuting said acidified base to form a smooth acidified yogurt bearing sweetened fortified base mix, to provide a nutritionally fortified cultured dairy product composition containing live and active cultures, having a culture count of at least 1.5×10⁸ cfu/gram, and having a finished product viscosity of 400 to 3500 cps at a temperature of 1° C. to 5° C.

2. The method of claim 1 wherein the process comprises the additional step of adding at least an acidic fruit base to provide a fruit containing product having a pH of 3.8 to 4.5.

3. The method of claim 2 wherein the fruit base is a fruit juice

4. The method of claim 2 wherein the fruit base of step E comprises fruit, starch, pectin, tricalcium phosphate, and sorbate.

5. The method of claim 2 wherein the fruit base comprises a magnesium source.

6. The method of claim 5 wherein the magnesium source is selected from the group consisting of dimagnesium phosphate, magnesium citrate, magnesium lactate, magnesium sulfate, magnesium oxide, magnesium chloride, magnesium carbonate, magnesium hydroxide and mixtures thereof.

7. The method of claim 1 wherein the process comprises the additional step of adding a flavor.

8. The method of claim 7 wherein at least a vitamin is admixed with said flavor.

9. The method of claim 1 wherein the process comprises the additional step of adding at least a color.

10. The method of claim 9 wherein at least a vitamin is admixed with said color.

11. The method of claim 1 wherein the base mix of step A comprises the sub-steps of:
a. admixing said milk ingredient, sugars, thickeners, vitamins and minerals,
b. pre-heating said base mix to a temperature of 62° C. to 75° C.
c. pasteurizing said base mix,
d. homogenizing said base mix, and
e. cooling said base mix to a temperature of i° C. to 5° C.

12. The method of claim 11 wherein the milk ingredient is selected from the group consisting of buttermilk, condensed milk, cream, non-fat dry milk, grade A whey, skim milk, whole milk, and or mixtures thereof.

13. The method of claim 11 wherein the sugar is selected from the group consisting of artificial sweeteners, high fructose corn syrup, granular fructose, sucrose and mixtures thereof.

14. The method of claim 11 wherein the thickener is selected from the group consisting of carboxyl methyl cellulose, gelatin, gellan gum, sodium alginate, high methoxy pectin, amidated high methoxy pectin, hydroxy propyl methyl cellulose, starch and mixtures thereof.

15. The method of claim 11 wherein the homogenized base mix is at a viscosity of 900 to 1800 cps at a temperature of 1° C. to 7° C.

16. The method of claim 11 wherein the homogenized base mix is at a pH of 6.4 to 6.7.

17. The method of claim 1 wherein the yogurt of step B comprises the sub-steps of:
a. providing a milk base,
b. homogenizing the milk base,
c. pasteurizing the homogenized milk base,
d. adjusting the pasteurized milk base to fermenting temperatures,
e. adding a starter culture, and
f. fermenting to desired acidities.

18. The method of claim 1 wherein the acid of step C is selected from the group consisting of adipic, citric, fumaric, lactic, and malic acid, and mixtures thereof.

19. The method of claim 1 wherein the fluid dairy product is at a finished pH of 4.1 to 4.7.

20. The method of claim 1 wherein the fluid dairy product has finished pH of 4.3 to 4.5.

21. The method of claim 1 wherein the fluid dairy product has a refrigerated shelf life of 60 days.

22. The method of claim 1 wherein the fluid dairy product has a mean particle size of 5 to 25 microns.

23. The method of claim 1 wherein the fluid dairy product has a mean particle size of 5 to 15 microns.

24. The method of claim 1 wherein the fluid dairy product has a mean particle size of 15 to 25 microns.

25. The method of claim 1 wherein the fluid dairy product has a finished viscosity of 400 to 1500 cps at a temperature of 1° C. to 7° C.

26. The method of claim 1 wherein the fluid dairy product has a finished viscosity of 1500 to 3200 cps at a temperature of 1° C. to 7° C.

27. A nutritionally fortified cultured dairy product comprising:
a. a nutritionally fortified, non-fermented dairy base having a mean particle size of 5 to 25 microns;
b. a yogurt;
c. an organic acid blend; containing live and active cultures, having a culture count of at least 1.5×10⁸ cfu/gram, and having a finished product viscosity of 400 to 3500 cps at a temperature of 1° C. to 7° C. and a final pH of 3.8 to 4.5.

28. The product of claim 27 additionally comprising a fruit base.

29. The product of claim 27 additionally comprising a flavor.

30. The product of claim 27 additionally comprising a color.

31. The product of claim 27 wherein the dairy base of step a is a blend that comprises:
a. about 4% to about 14% milk solids;
b. about 0.1% to about 1.5% thickening agent;
c. about 9% to about 15% sweetener; and
d. about 0.01% to about 0.5% vitamin/mineral blend.

32. The product of claim 31 wherein the milk solids is selected from the group consisting of buttermilk, condensed milk, cream, non-fat dry milk, grade A whey, skim milk, whole milk, soy milk and or mixtures thereof.

33. The product of claim 31 wherein the sweetener is selected from the group consisting of artificial sweeteners, high fructose corn syrup, granular fructose, sucrose, and mixtures thereof.

34. The product of claim 31 wherein the vitamin/mineral blend is selected from the group consisting of vitamin A, vitamin D, vitamin E, vitamin C, folate, thiamin, riboflavin, niacin, pyrixodine, cyanocobalamine, biotin, pantothenic acid, calcium, phosphorus, iodine, iron, magnesium, zinc, manganese, and mixtures thereof.

35. The product of claim 31 wherein a combination of at least six vitamins and minerals comprise the vitamin/mineral blend.

36. The product of claim 31 wherein a combination of at least twelve vitamins and minerals comprise the vitamin/mineral blend.

37. The product of claim 31 wherein the thickening agent is selected from the group consisting of pectin, gellan gum, starch, amidated carboxy methyl cellulose, carboxy methyl cellulose, gelatin, sodium alginate, hydroxy propyl methyl cellulose and mixtures thereof.

38. The product of claim 27 having a mean particle size of 5 to 15 microns.

39. The product of claim 27 having a mean particle size of 15 to 25 microns.

40. The product of claim 27 wherein the product is produced at refrigeration temperatures.

41. The product of claim 27 having a viscosity of 400 to 1500 cps at a temperature of 1° C. to 7° C.

42. The product of claim 27 having a viscosity of 1500 to 3200 cps at a temperature of 1° C. to 7° C.

43. The product of claim 27 having a low fat content of less than 1% by weight.

44. The product of claim 27 having a low fat content of less than 0.5% by weight.

45. The product of claim 27 having a fat free content.

46. The product of claim 27 having a finished pH of 4.1 to 4.7.

47. The product of claim 27 having a finished pH of 4.3 to 4.5.

48. The product of claim 27 having a finished pH of 4.4 to 4.7.

49. The product of claim 27 having a shelf life of 60 days.

50. The product of claim 27 in the form of a fluid beverage.

51. The product of claim 27 in the form of a frozen aerated soft serve dessert.

52. The product of claim 27 in the form of a carbonated yogurt beverage.

53. The product of claim 27 wherein a quantity of product is disposed within and packaged in a sealed container.

54. The article of claim 53 wherein the sealed container is fabricated from carbon black regrind and plastic, laminated to minimize product oxidation.
